(19) United States
(12) Patent Application Publication
(10) Pub. No.: US 2011/0266245 A1
(43) Pub. Date: Nov. 3, 2011

(54) Infant Oral Feeding System

(76) Inventor: Chantal Lau, Santa Fe, NM (US)

(21) Appl. No.: 13/184,436

(22) Filed: Jul. 15, 2011

Related U.S. Application Data
(63) Continuation-in-part of application No. 12/675,134, filed on Sep. 21, 2010.

(30) Foreign Application Priority Data
Sep. 4, 2007 (FR) 0706190
Aug. 29, 2008 (FR) PCT/FR2008/001217

(51) Int. Cl. A61J 9/04; E03C 1/10

(52) U.S. Cl. 215/11.5; 137/215

(57) ABSTRACT

An oral feeding system using anti-drip visual positioning markers and a unidirectional, anti-vacuum valve to simultaneously and rapidly eliminate the hydrostatic pressure and vacuum build-up, respectively, normally occurring in conventional feeding bottles. In one version, the anti-drip visual positioning markers and valve are part of the same bottle (standard or ergonomically-shaped). In another version, a nipple is held by a nipple crown that screws onto an adaptor with anti-drip visual positioning markers and a hole into which the anti-vacuum valve is inserted. The adaptor screws onto a standard or ergonomically designed feeding bottle. The anti-vacuum valve can have one or more extended tabs that make it easier to grip when removing the valve. The use of an ergonomically shaped, hard-wall bottle optimizes caregivers' comfort and minimize potential hand and/or wrist injury. Transparent materials can be used for the components of the system.

### CROSS-REFERENCE TO RELATED APPLICATIONS

The present application is a Continuation-in-Part of pending U.S. patent application Ser. No. 12/675,134 by Lau et al., filed Sep. 21, 2010 and published as US patent application publication No. 2011/0000867 A1 on Jan. 6, 2011; which itself claims priority to PCT Application No. PCT/FR2008/001217 filed Aug. 29, 2008; which itself claims priority to France application No. 0706190 filed Sep. 4, 2007, all of which is incorporated herein by reference.

### BACKGROUND OF THE INVENTION

1. Field of the Invention

This invention pertains to a new infant oral feeding system specifically designed to: (1) enhance infants' safety, efficiency, and comfort during bottle feeding and (2) be used as a training tool to enhance the development of mature nutritive sucking skills. It is a feeding system designed with a special module built into the feeding system, or, as a separate adaptor that can be affixed to an existing feeding bottle. This system eliminates two physical properties inherent to conventional feeding bottles that work against infants' developing oral feeding skills.

2. Introduction

The aptitude of infants to feed by mouth safely and efficiently depends on the maturity of their sucking, swallowing and breathing skills, along with their ability to coordinate these three functions in order to avoid adverse events, e.g., choking, gagging, ‘turning blue’. The majority of infants born at term gestation (37 to 42 weeks gestation) can control and regulate the strength and duration of their sucking in order to maintain a flow they can handle safely due to the mature level of their oral feeding skills. However, this is not necessarily the case for all infants, namely: those who fatigue rapidly, are born prematurely (less than 37 weeks gestation), or have chronic conditions such as congenital anomalies. For these infants, bottle-feeding presents risks of choking, coughing, or aspiration when the flow or the pressure of the liquid out of the bottle is too great for the maturity level of their oral feeding skills.

Bottle feeding with a conventional bottle has two physical properties that naturally work against infants' developing oral feeding skills, namely the hydrostatic pressure present in an inverted bottle and the vacuum build-up occurring when the bottle empties during a feeding session.

Hydrostatic pressure: When a bottle is inverted, milk drips out of the bottle as a result of the positive hydrostatic pressure exerted over the nipple opening (see FIG. 1). This pressure can be changed depending on the angle at which the bottle is tilted. However, few people know how much to tip/tilt a bottle during a feeding in order to minimize such drip. When infants are not ready to suck and are faced with a sustained flow, they cannot control their feeding with milk accumulating in their mouth. They are forced to swallow in order to avoid choking, coughing, gagging and/or aspiration. At the same time, such a situation may interfere with their respiration and/or their need to take a rest, leading to respiratory instability and/or fatigue, respectively. Over the long term, these babies may become aversive to oral feeding or develop aspiration-pneumonia resulting from frequent liquid penetration into the lungs.

Vacuum build-up: As babies feed and milk empties out of the bottle, the negative pressure within the bottle (or vacuum) increases. This growing vacuum becomes a resistance against the flow of liquid out of the bottle. Under such conditions, infants must exert an increasingly greater sucking force to counterbalance the increased vacuum in order to continue withdrawing milk (FIG. 2). This inefficiency leads to unnecessary increase in fatigue and energy expenditure, the latter being better spent for growth and development.

Caregivers who are bottle feeding an infant have no way of knowing the flow rate that he/she can tolerate unless the latter shows signs of discomfort or distress, e.g., choking, spitting, pulling away. Thus, giving control of the feeding to the caregiver puts infants at risk of adverse events threatening their safety, efficiency, and comfort.

Therefore, given the drawbacks existing in conventional infant feeding bottles, i.e., the existence of a detrimental hydrostatic pressure, vacuum build-up within the bottle, and the lack of control infants have over their own feeding, the latter are at risk of encountering oral feeding difficulties that can lead to unsafe and inefficient feeding, oral feeding aversion, and failure to thrive, while increasing the duration of hospitalization and maternal/family stress.

Institut National de la Propriété Industrielle INPI #07/06190 describes an infant feeding bottle that substantially eliminates the hydrostatic pressure normally present in an inverted baby bottle. It can comprise a bottle collar to which a nipple is attached, characterized by at least two visual markers placed on a circumference near the bottle collar, and distant from each other around the central axis of the bottle. One of these markers defines the angular position of the baby bottle around its central axis and based on which the other marker(s) indicates a point by which the surface level of the liquid must reach so that the hydrostatic pressure at the level of the opening of the nipple is approximately zero.

U.S. Pat. No. 7,537,128 describes “a nursing bottle [ . . . ] which possess a novel venting system that allows ambient air to enter the nursing bottle to equalize the internal and external pressures and prevent nipple collapse. Preventing nursing bottle nipple collapse reduces the amount of sucking by infants necessary to extract milk from the bottle and eliminates air in the infant's stomach. Liquid is prevented from exiting the bottle by means of capillary action. The invention can be utilized with any standard nursing bottle.”

U.S. Pat. No. 5,944,205 describes a vented baby bottle comprising “an upper portion of the container that includes a bore formed therein. A valve is situated within the bore of the container. Upon a suction being applied to the interior space of the container, air enters the container through the valve for equalizing pressure therein”.

The following references provide useful background information on oral feeding problems in infants, and are incorporated herein by reference:
Wolff P H, The serial organization of sucking in the young infant. Pediatrics 1968; 42: 943-956;
Sameroff A J, The components of sucking in the human newborn. J Exp Child Psychol 1968; 6:607-623; and
Wolf L S, Glass R P, Feeding and swallowing disorders in infancy: assessment and management. Tucson: Therapy Skills Builders, 1992.
Arvedson J C, Lefton-Greif M A, Pediatric videofluoroscopic swallow studies. A profession manual with caregiver guidelines. San Antonio: Communication Skill Builders, 1998.

### SUMMARY OF THE INVENTION

The present invention is an infant oral feeding system that comprises a unique combination of features that rapidly eliminates both the natural hydrostatic pressure generated in an inverted bottle, and the vacuum build-up naturally occurring when milk is withdrawn from a bottle during a feeding when the infant's tight seal around the nipple prevents air inflow. The elimination of the hydrostatic pressure halts the automatic milk drip that would normally occur allowing infants to feed more safely as they can regulate their own milk flow as a function of the maturity level of their individual oral feeding skills. The elimination of the vacuum build-up eliminates the resistance against milk outflow from the bottle allowing infants to become more efficient, as there is no need to counteract/overcome the negative force inside the bottle (vacuum), i.e., more milk is obtained for a given sucking force/effort. This decreases energy expenditure.

A bottle that only eliminates the hydrostatic pressure does not address the drawback created by the vacuum build-up, i.e., increased resistance to milk outflow. A bottle only addressing the vacuum build-up does not address the drawback created by the presence of a hydrostatic pressure, i.e., increased flow rate, whether the infant is ready to feed or not. Thus, solving both of these problems simultaneously provides a more controlled flow rate of liquid to the infant while optimizing his/her safety and efficiency.

Therefore, this invention offers several important objects, all of which benefit the infants. It gives control of the feeding to infants rather than to their caregivers. The latter do not know the flow rate that their baby can tolerate. This benefit is of upmost importance in ensuring infants' safety during oral feeding, as milk only flows when they are actively sucking. It increases infants' efficiency when feeding by mouth. In the absence of resistance against flow within the bottle, infants are more efficient. This benefit is of great significance as less energy is spent towards feeding and more toward the infants' growth and development. It increases infants' comfort during feeding. The ability of infants to regulate their own flow as a function of their individual skills and tolerance will decrease negative feeding experience and potential short- and long-term oral feeding aversion.

It is a feeding system that is simple to use. Caregivers do not need to understand its physical properties, but only adjust milk level to particular anti-drip visual positioning markers by appropriately tipping/tilting the bottle. The internal vacuum build-up will be automatically corrected by the anti-vacuum valve. This benefit will increase caregivers' confidence and comfort when feeding their infant, thereby decreasing their stress.

At least two different versions of this feeding system can be manufactured. The anti-drip visual positioning marker(s), and anti-vacuum valve can be built: 1) into the feeding bottle, or 2) as a separate adaptor that can be used with an existing feeding bottle, as will be described. The complete feeding bottle and adaptor can be available in different sizes for models using standard and wide-based nipples. The anti-vacuum valve can be available in one size fitting either standard or wide-base models. Additionally, the adaptor can be available in two sizes to fit existing bottle that use standard or wide-based nipples.

Both versions of the feeding system are practical and economical. The feeding bottle, adaptor, and valve can be separate components that can be replaced and purchased individually, and are easy to clean ensuring no contamination from milk residue. This convenience eliminates the need of purchasing an entire feeding system or an entire adaptor when necessary.

The above and other objects of the present invention will become apparent to those skilled in the art upon reading the accompanying description, drawings, and claims set forth herein.

### BRIEF DESCRIPTION OF THE DRAWINGS

FIG. 1 shows a side view of a standard non-vented infant feeding bottle.

FIG. 2 shows a plot of experimental data of pressure measured inside of a non-vented bottle versus time during an infant feeding session.

FIG. 3A shows an isometric assembly view of a first embodiment of an infant oral feeding system, according to the present invention.

FIG. 3B shows an isometric assembly view of a second embodiment of an infant oral feeding system, according to the present invention.

FIGS. 4A-J show various views of different examples of anti-vacuum valves, according to the present invention.

FIGS. 5A-D show isometric and side views of an embodiment of an adaptor that can be used with an existing feeding bottle, according to the present invention

FIGS. 6A and 6B shows cross-section and isometric views of an ergonomic bottle design, according to the present invention.

FIGS. 7A-D show side and cross-section views of an adaptor with an anti-vacuum valve oriented sideways.

FIG. 8A shows a schematic setup for the continuous measurement of internal vacuum build-up.

FIG. 8B shows a schematic of a typical pressure trace versus time generated by an infant for a single suction.

FIG. 8C shows an actual pressure trace versus time within a valved bottle, showing re-equilibration of internal pressure to 1 atmosphere following each suck at amplitude of ˜2 mmHg.

FIGS. 9A and 9B show cross-sectional and elevation views, respectively of a first example of a pair of valve guides, according to the present invention.

FIGS. 9C and 9D show cross-sectional and elevation views, respectively of a second example of a pair of valve guides, according to the present invention.

FIG. 10 shows an isometric view of an embodiment of an infant oral feeding system with multiple anti-drip marker lines, according to the present invention.

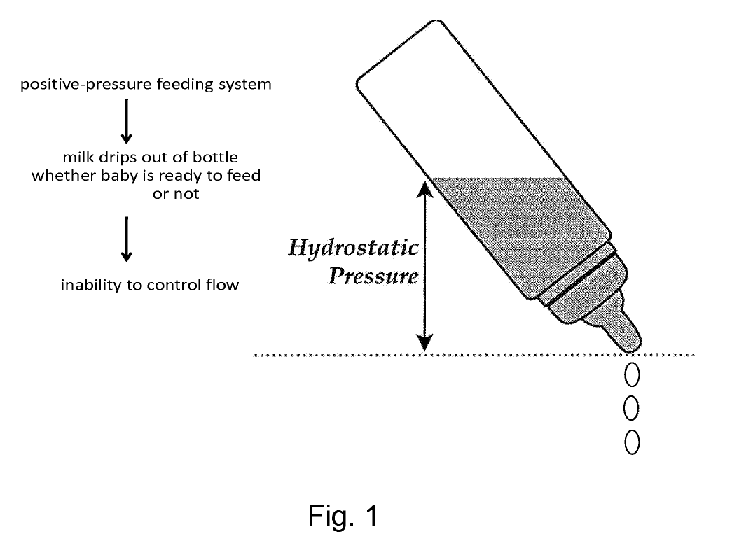

### DETAILED DESCRIPTION OF THE INVENTION

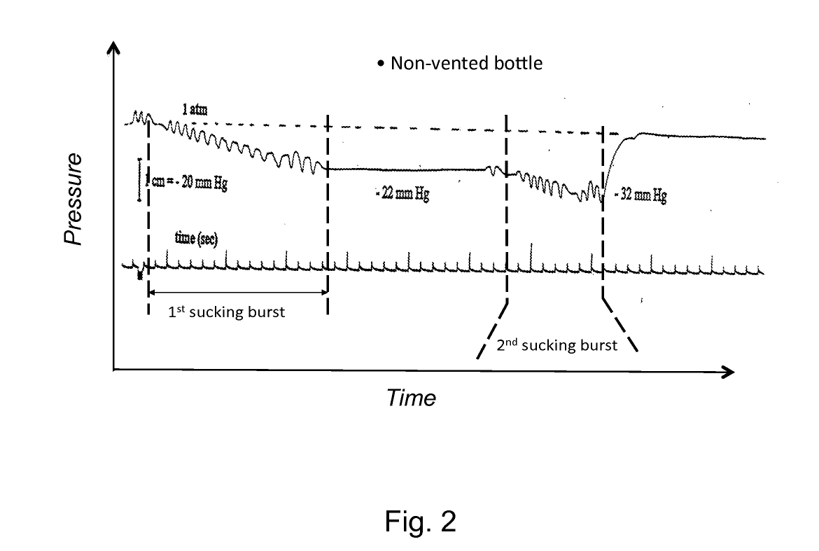

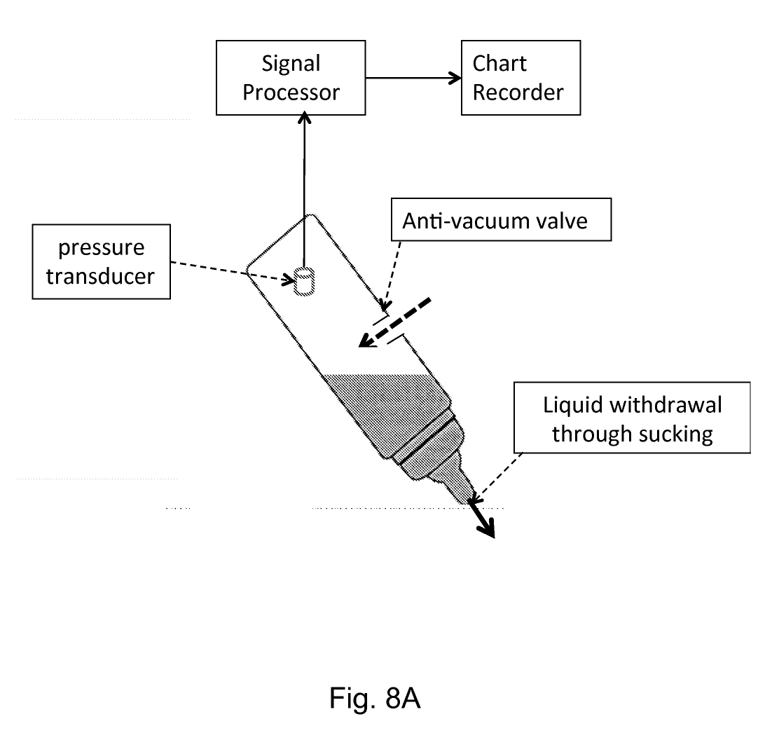

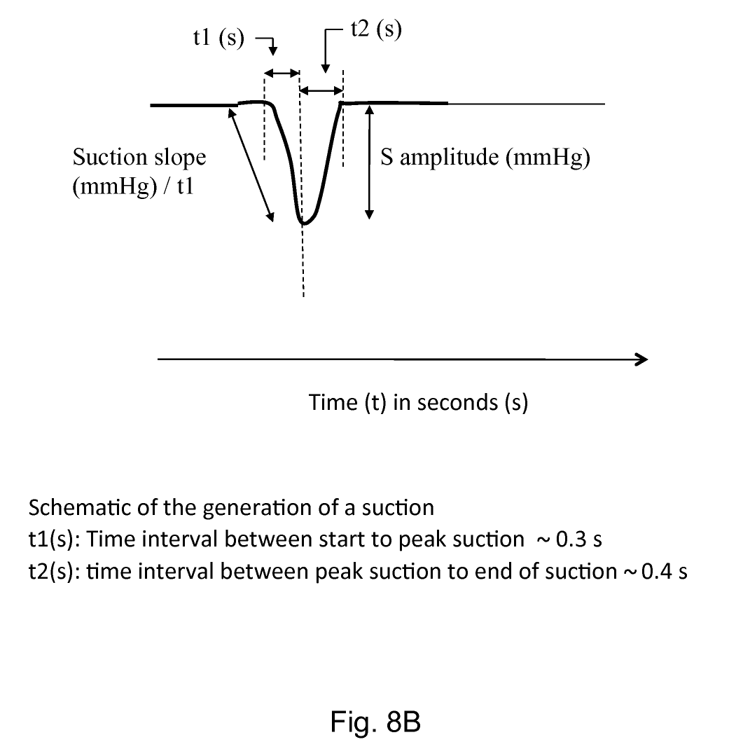

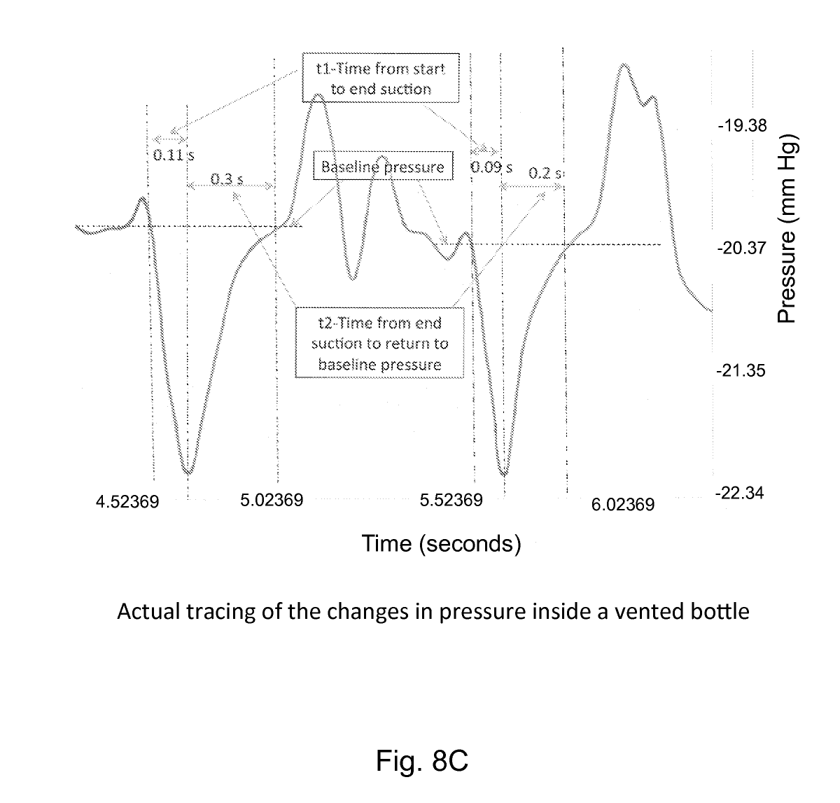

The present invention evolved from a series of experiments performed by the Inventor, Dr. Chantal Lau, where the pressure inside of a feeding bottle was measured with miniature pressure transducers (FIG. 8A). Dr. Lau measured the time history of negative pressure (vacuum) buildup during infant feeding (FIG. 2, FIG. 8C). The pressure traces were compared between a standard (non-vented) infant feeding bottle (FIG. 2), and a specially designed, vacuum-free, vented bottle that was open to the atmosphere (FIG. 8C). Those experiments (see, for example, FIG. 2), documented the sequential buildup of vacuum pressure (e.g., −32 mm Hg) in non-vented standard bottles, during a series of sucking actions by the infant. The experiments also demonstrated the benefit of using a vented, vacuum-free bottle system on infants' oral feeding performance. This work is described in the following references, which are incorporated herein by reference:
Lau C, Schanler R J. Oral feeding in premature infants: advantage of a self-paced milk flow. Acta Paediatr. 2000; 89:453-9.
Fucile S, Gisel E, Schanler R J, Lau C. A Controlled-flow Vacuum-free Bottle System Enhances Preterm Infants' Nutritive Sucking Skills. Dysphagia 2009; 24:145-151.

Other related research by Dr. Lau, is described in the following papers, all of which are incorporated herein by reference:
Lau C, Hurst N. Oral feeding in infants. Curr Probl Pediatr. 1999; 29:105-24.
Lau C, Alagugurusamy R, Schanler R J, Smith E O, Shulman R J. Characterization of the developmental stages of sucking in preterm infants during bottle feeding. Acta Paediatr. 2000; 89:846-52.
Lau C, Smith E O, Schanler R J. Coordination of suck-swallow and swallow respiration in preterm infants. Acta Paediatr. 2003; 92:721-7.
Lau C, Sheena H R, Shulman R J, Schanler R J. Oral feeding in low birth weight infants. J. Pediatr. 1997; 130:561-9.
Lau C, Kusnierczyk I. Quantitative evaluation of infants nonnutritive and nutritive sucking. Dysphagia. 2001; 16:58-67.
Scheel C E, Schanler R J, Lau C. Does the choice of bottle nipple affect oral feeding performance of very-low-birth-weight (VLBW) infants? Acta Paediatr. 2005; 94:1-8.
Alagugurusamy R, Schanler R J, Lau C. Identification of stages of sucking behavior in premature infants that may be used as indicators of feeding performance. Pediatr Res 1998; 43: 255A.
Lau C, Schanler R J. Oral motor function in the neonate. Clin Perinatol 1996; 23: 161-78.
Fucile S, Gisel E, Lau C. Oral stimulation accelerates the transition from tube to oral feeding in preterm infants. J Pediatr 2002; 141: 230-6.
Fucile S, Gisel E G, Lau C. Effect of an oral stimulation program on sucking skill maturation of preterm infants. Dev Med Child Neurol 2005; 47: 158-62.
Amaizu N, Shulman R J, Schanler R J, Lau C. Maturation of oral feeding skills in preterm infants. Acta Paediatrica 2008 97, pp. 61-67.

We define the term “infant” as broadly including any infant mammal, not just human infants. Also, the term “infant” is broadly defined as including any age, i.e., ranging from premature infants (and mammals) to elderly people (and mammals).

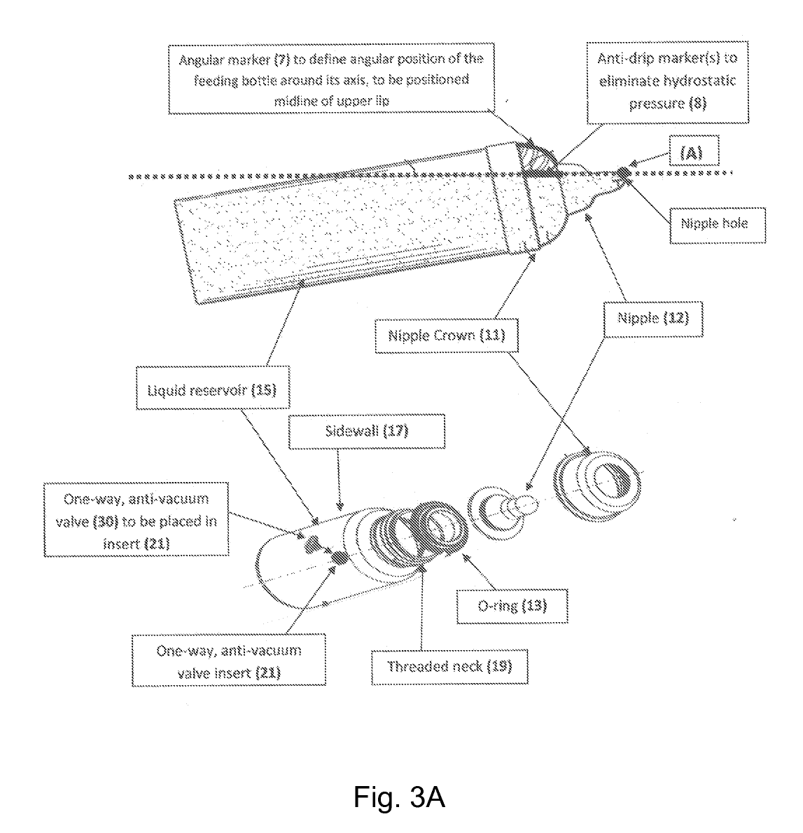

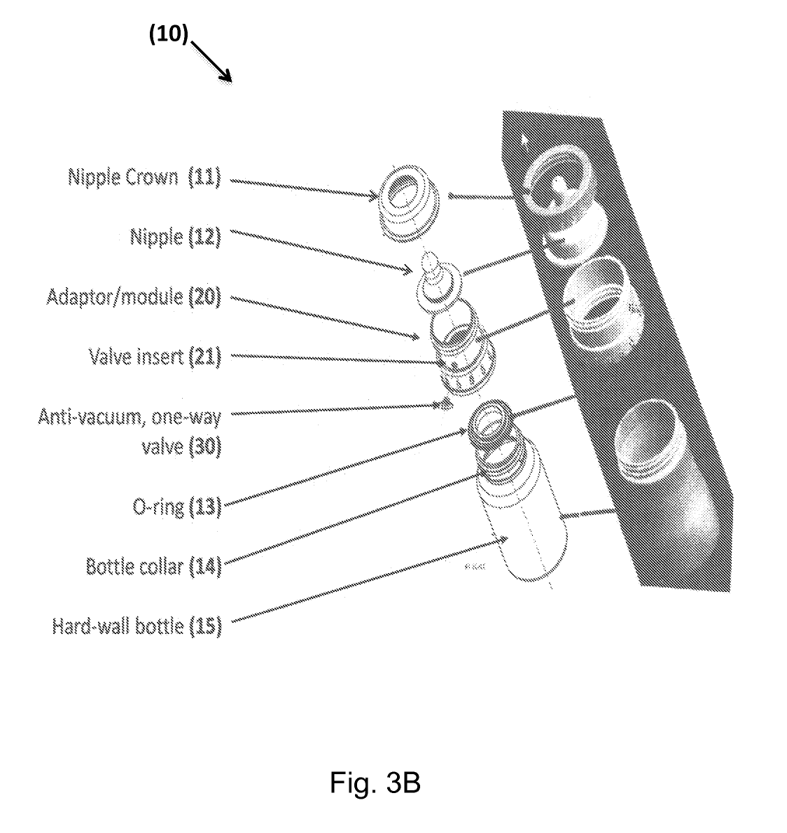

FIG. 3A shows an assembly drawing of a first embodiment of a vented infant oral feeding system (10) according to the present invention; namely, the anti-drip visual positioning markers (8) and the valve insert hole (21), which is built into a customized liquid reservoir (15). As can be seen from the drawings, infant oral feeding system (10) comprises: a vented liquid reservoir/bottle (15) comprising at least one anti-drip visual-positioning marker means (8) for eliminating hydrostatic pressure during feeding, and an anti-vacuum valve (30) that can be inserted into valve insert hole (21). Feeding system (10) can additionally comprise an O-ring (13), nipple crown (11), and nipple (12). The components of feeding system (10) can be variable in total height and diameter to accommodate optimal height, shape, and diameter. Additionally, all the components shown can be variable in color, opacity, transparency, and design. Valve insert hole (21), and anti-vacuum valve (30), are preferably located on the sidewall (17) of reservoir (15), at a position relatively close, or adjacent, to the threaded neck (19) of reservoir (15). The one or more anti-drip visual positioning markers (8) can be located on the nipple crown (11) as illustrated, or on the liquid reservoir (15). Anti-vacuum valve (30) can be easily removed and replaced by hand, for easy cleaning or replacement. Alternatively, anti-vacuum valve (30) can be permanently attached to reservoir (15).

The location, size, shape, orientation, placement, color, and number of anti-drip markers (8) is described in more detail in the aforementioned U.S. patent application Ser. No. 12/675,134 by Lau et al, which is incorporated herein by reference. It describes [ . . . ] “a feeding bottle, [ . . . ] that comprises at least two visual marks located on one and the same circumference near the neck or near the teat and separated from one another about the axis of the feeding bottle, one of these markers defining an angular position of the feeding bottle around its axis, [angular marker (7)] for which the other marker [anti-drip marker(s) (8)] indicates a point through which the free surface of the liquid [ . . . ] needs to pass in order for the hydrostatic pressure of the liquid on an outlet orifice of the teat to be substantially zero.” The positioning of the visual marker(s) (8) in relation to the angular marker (7) on the same circumference near the neck or near the teat will be determined such that a line drawn between the visual marker(s) (8) and a point slightly above the nipple hole (point “A” in FIG. 3A) is horizontal. The positioning of these visual markers will vary depending upon the shape and size of the bottles. Additionally, multiple visual markers (8) (e.g., lines) can be placed to assist caregivers to rapidly adjust liquid level when the bottle is full and when partially empty. The elimination of the hydrostatic pressure as described is achieved independently of the volume, type, and thickness of fluid within the bottle, e.g., water, mother's milk, formula.

FIG. 3A shows an example of an angular marker (7) and anti-drip marker (8), comprising a short line of a contrasting color printed on the nipple crown or a raised line (bump) molded into the nipple crown, positioned in such a manner that the respective markers (7 and 8) serve as visual positional tools to aid the caregiver, respectively, in angling and tipping the bottle to the correct inclination (angle of tilt) so that the fluid level line continuously passes through the different anti-drip markers, e.g., lines as the bottle empties. These markers serve as visual positional tools to aid caregivers in angling/tipping the bottle to the correct inclination (angle of tilt) so that the fluid level line passes through the anti-drip markers, e.g. lines. When done properly, this ensures that the height of the fluid level above the nipple opening is close to zero, thereby minimizing the hydrostatic pressure at the nipple opening. The use of the present anti-drip marker means is characterized by the sustained and immediate elimination of the hydrostatic pressure by means of the transparency of the nipple (12), nipple crown (11), and customized bottle (15) or transparent adaptor (20) that allow caregivers to accurately adjust the level of milk within the bottle to the opening of the infant's mouth as the volume of milk within the bottle decreases. Depending upon shape and height of the customized bottle (15), the angular separation between the anti-drip positioning marks of the free surface of the liquid and the angular positioning of the feeding bottle ranges within 90 degrees.

FIG. 3B shows an assembly view of a second embodiment of a vented infant oral feeding system (10), where an innovative adaptor (20) is used with an existing (conventional) baby bottle (15), according to the concepts of the present invention. System (10) can comprise six separate elements: a conventional bottle (15) with a threaded bottle collar (14), an O-ring (13), an adaptor (20) with anti-drip visual positioning markers (8) and an anti-vacuum valve insert hole (21), a replaceable anti-vacuum valve (30) for inserting into hole (21), a nipple crown (11), and a nipple (12). Alternatively, the anti-drip visual positioning markers (8) can be located on the nipple crown (11). The assembly of the infant oral feeding system (10) can be variable in total height and diameter to accommodate optimal height, shape, and diameter of each of the six elements. Additionally, all the components shown in assembly (10) can be variable in color, opacity, transparency, and design.

Adaptor (20) incorporates the valve insert hole (21), into which the anti-vacuum valve (30) can be inserted. Nipple crown (11), nipple (12), feeding reservoir (15), and adaptor (20) can be made of an appropriate transparent material. Such transparencies allow for the rapid elimination of the hydrostatic pressure by visually aligning the liquid level to the anti-drip visual positioning markers placed on the nipple crown and/or to the lower edge of the upper lip of the infant. Optionally, decorative designs or patterns (not shown) can be attached to, printed onto, or incorporated into, the feeding reservoir or bottle (15).

When feeding an infant, the bottle 15 or adaptor 20 can be adjusted such that the anti-vacuum valve (30) faces upward. As such, valve (30) can be utilized as a midline angular marker, replacing the angular marker (7). Additionally, such positioning will eliminate any milk leak that may occur through the valve. Additionally, to prevent potential milk leakage through the valve, calibration volumes, e.g., 1, 2, 4, 6, 8 oz, can be placed on the customized bottles with recommendation of not filling up the bottle beyond its largest volume. When valve (30) is used as a midline angular marker, then one or more anti-drip visual positioning markers (8) can be positioned on either side of and equidistant from the valve (30). The anti-vacuum valve (30) can be easily removed and replaced by hand, for easy cleaning or replacement. Alternatively, anti-vacuum valve (30) can be permanently attached to adaptor (20).

Each individual component of the various versions of the oral feeding system can be manufactured with the optimal material available on the market that is safe for human use as recommended by the Consumer Product Safety Improvement Act (CPSIA), e.g., silicone, polypropylene, free from Bisphenol-A, Phthalates, Polyvinyl chloride (PVC), or meeting the minimal requirements recommended by CPSIA.

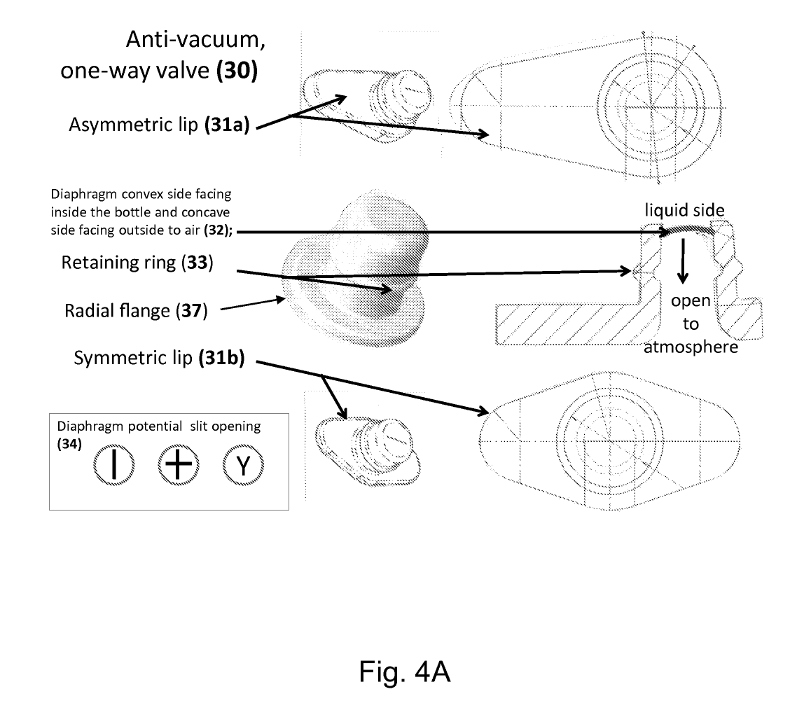

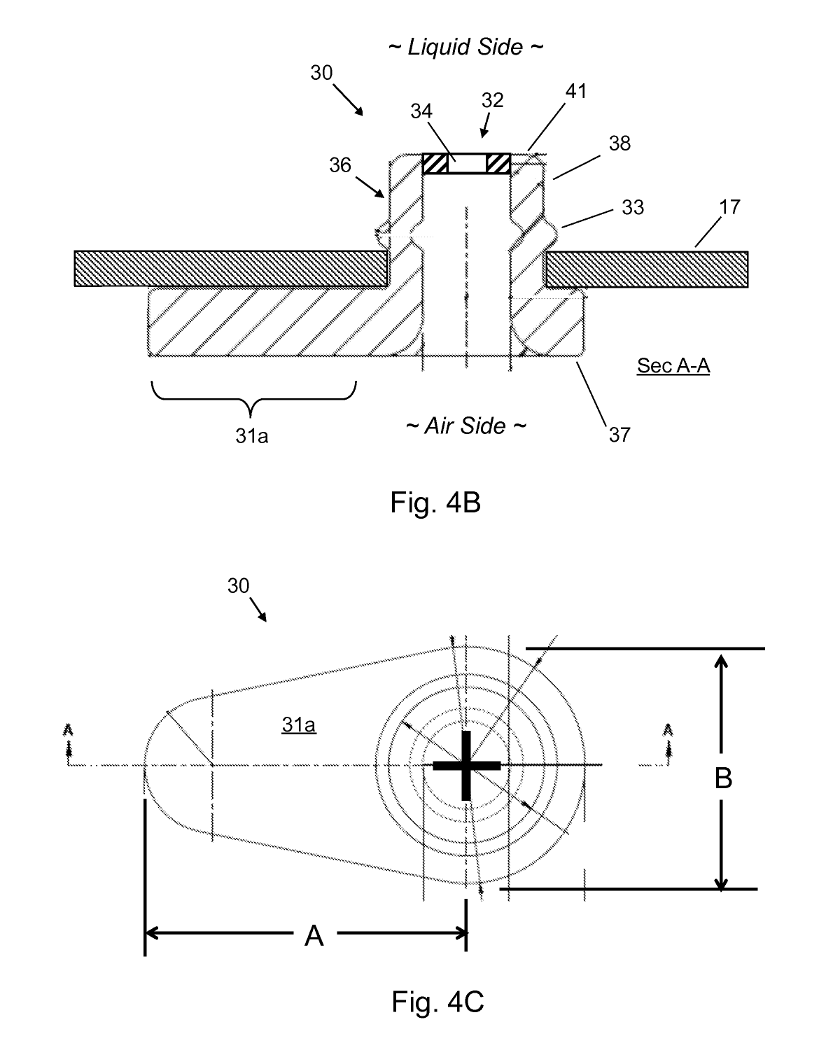

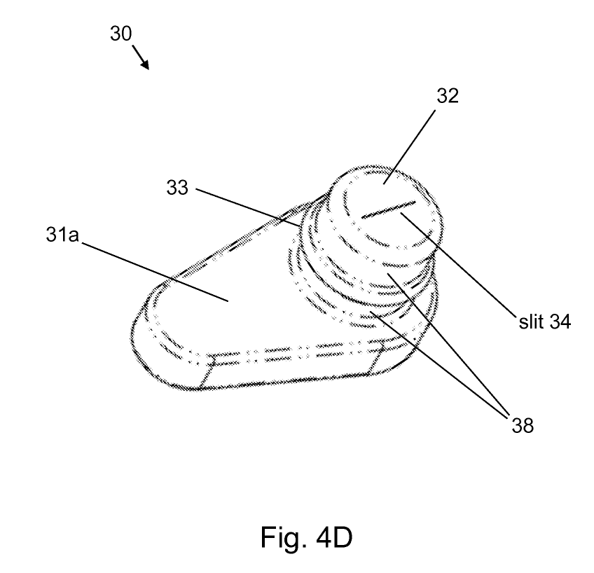

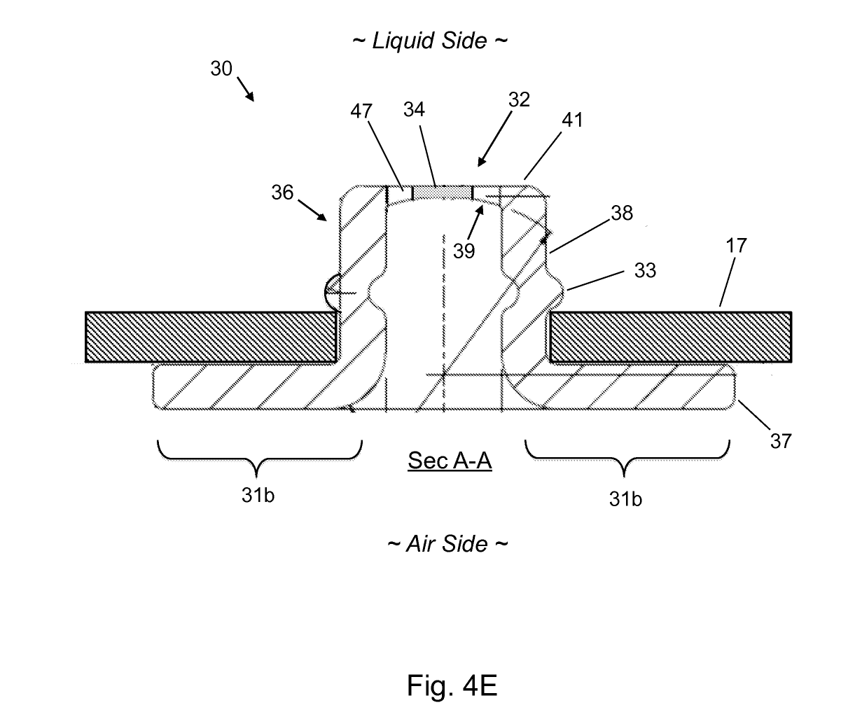

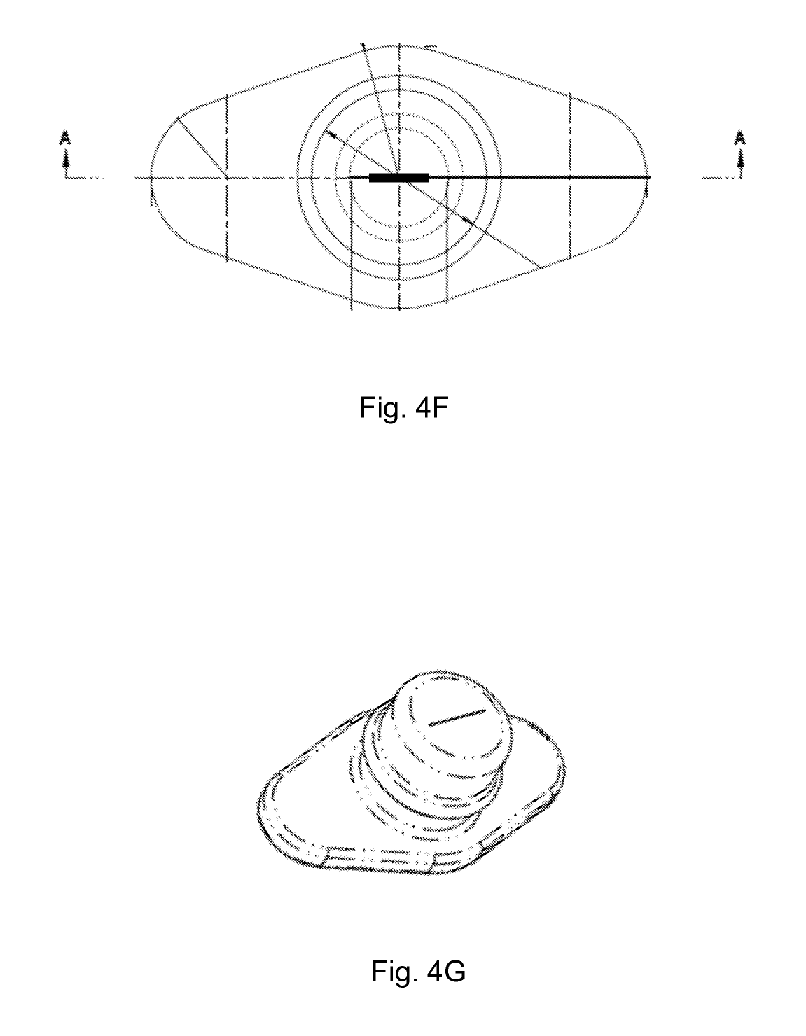

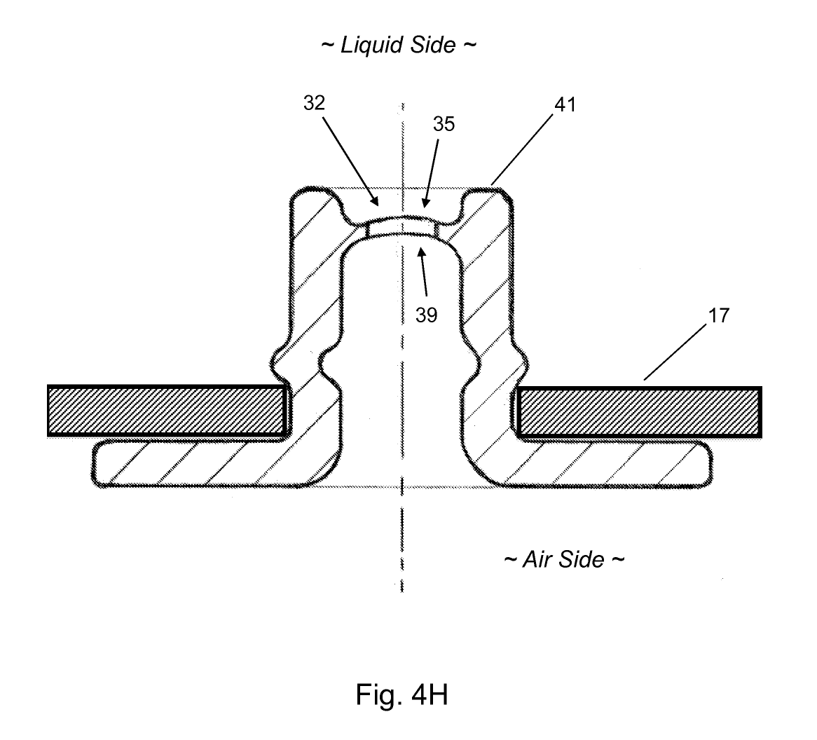

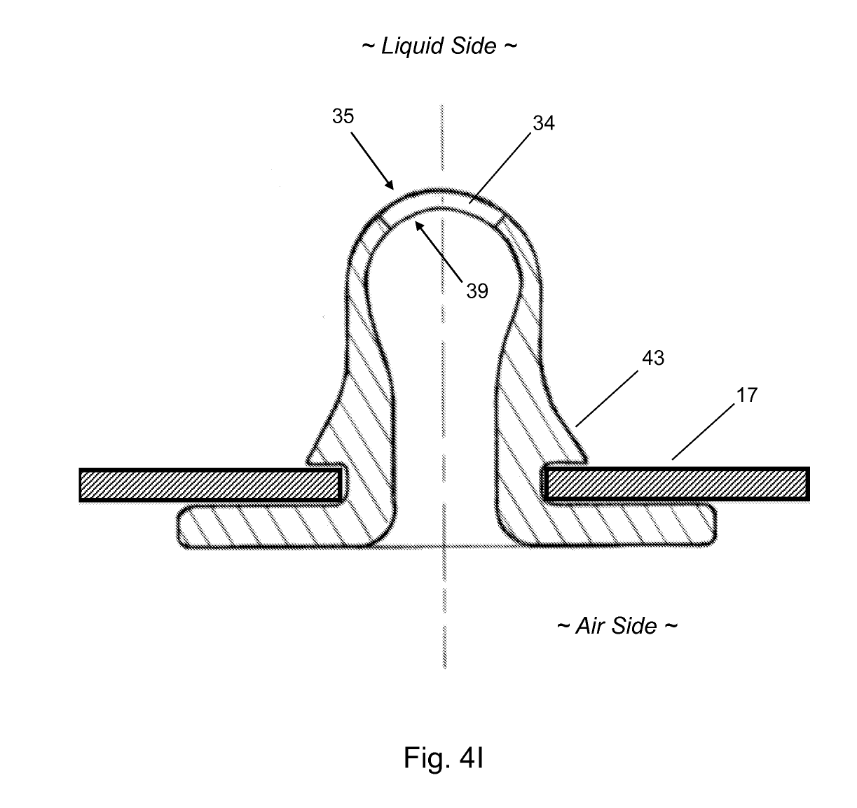

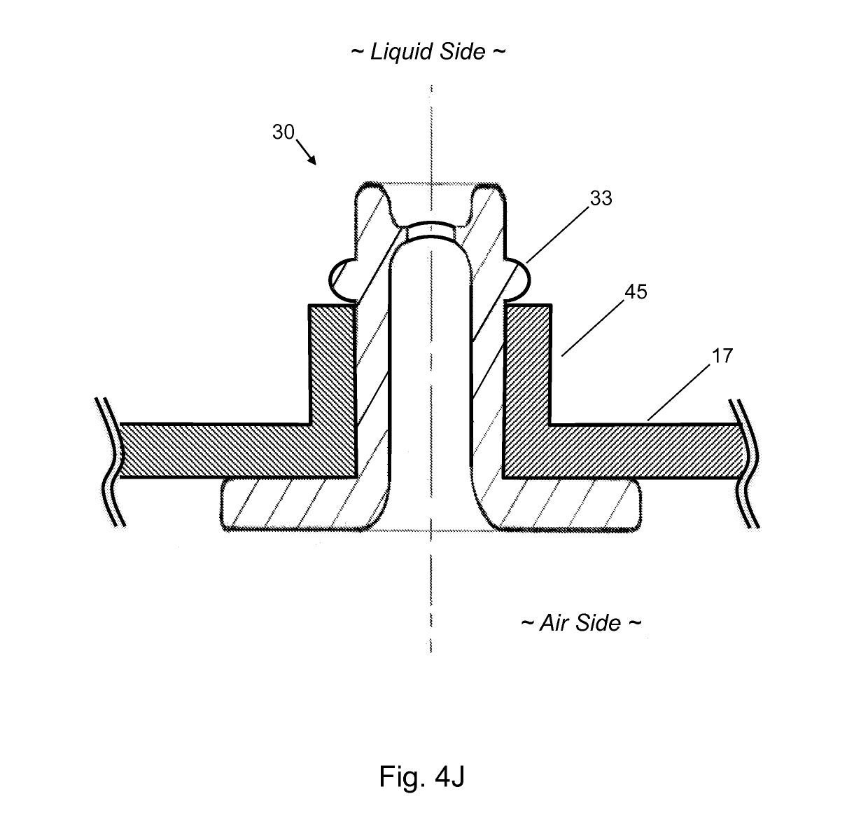

FIGS. 4A-J show different embodiments of an anti-vacuum, unidirectional (one-way) check valve (30), according to the present invention. Valve 30 allows for a unidirectional airflow inward when a pressure differential is greater outside than within the feeding system. With a reverse situation, i.e., pressure differential greater within than without, backflow is checked (i.e., the valve remains closed when liquid is above the valve). Valve (30) can comprise, for example, a diaphragm with a slit-type membrane, a single flap closure, a pair of “duck-billed” flaps, or a ball-type mechanism. Valve (30) is “normally closed”, and can be pre-loaded. Pre-loaded valves require some significant pressure (“opening pressure”) in the forward flow direction to obtain an onset of flow. Valve (30) can be a monolithic, slit-type valve made out of a flexible, elastomeric material (e.g., silicone).

In a preferred embodiment, valve (30) comprises:
a tube (36), having a sidewall (38) and a central axis;
a near end, an opposing far end, and a top end (41);
a slit-type diaphragm (32), located at, or near, the far end of the valve, continuous with the sidewall, comprising a membrane (47) with a slit (34) disposed through the membrane;
a radial flange (37), located at the near end of the valve, continuous with the sidewall, extending radially outwards from the tube's sidewall in a direction perpendicular to the tube's central axis; and
a circumferential retaining ring (33), continuous with the sidewall, disposed in-between the diaphragm (32) and the radial flange (37). We define the diaphragm 32 as comprising two parts: membrane 47 and one or more slit(s) 34 in the membrane 47.

Radial flange (37) prevents valve (30) from falling through opening 21 into the bottle (15); as well as providing a sealing surface for making a leak-tight seal. Radial flange (37) can be circular, as shown in the middle of FIG. 4A or non-circular (FIGS. 4B-G). In FIGS. 4A and 4C, radial flange (37) has been extended radially outwards from the valve's central axis to make one or more extended “tabs” (wings, lips) (31a, 31b). These elongated tabs can be used as a “handle” to grab the valve for easy insertion or removal into the feeding system (10) or adaptor (20). FIGS. 4B-D illustrate an example of a single (asymmetric) tab (31a). FIGS. 4E-G illustrate an example of a symmetric pair of tabs (31b). The shape of the tabs may vary in design. The aspect ratio, A/B, of a tab (asymmetric or symmetric), as defined in FIG. 4C, can be greater than or equal to 1. Alternatively, the aspect ratio, A/B, can be greater than or equal to 1.5. Alternatively, the aspect ratio, A/B, can be greater than or equal to 2.

Referring still to FIGS. 4A-J; disposed at (or near) the top end (39) of tube 36 is an integral diaphragm (32) with a thin membrane (47) and at least one slit-type opening (34) through the membrane. The opening to atmosphere may comprise, for example, a single slit, a crosscut slit, or a Y-cut slit, as shown in FIG. 4A. Alternatively, a “duck-billed” type one-way valve design can be used, as is well known in the art. Slit-type diaphragm (32) acts as a check-valve type pressure equalizer to prevent build up of vacuum within the bottle when liquid is dispensed. In some embodiments, the mechanical design of the diaphragm (e.g., thickness, diameter, radius of curvature, modulus of elasticity, shape, geometry and number of slits, etc.) will be appropriately chosen so that the elimination of the vacuum after each suck occurs in less than or equal to 0.2 or 0.4 seconds (See FIG. 8C). Since infants nutritively suck at a rate of about one suck per second, this rapid return to one atmosphere (e.g., in less than 0.2 or 0.4 seconds) with this slit-type valve allows at least 0.8 or 0.6 seconds, respectively, for the infant to generate the next suck in a vacuum-free environment. In the absence of any resistance against flow out of the bottle, the infant will feed at optimal efficiency.

The mechanical design of the diaphragm, membrane, and slit(s) (e.g., thickness, radius of curvature, number of slits, material, etc.) can be chosen so that the valve has an opening pressure differential across the diaphragm in the range of 1-10 mm Hg. Alternatively, the opening pressure differential across the diaphragm can be in the range of 25-75 mm Hg. Alternatively, the opening pressure differential can be in range of 75-150 mm Hg. Alternatively, the thickness, radius of curvature, and number of slits, can be chosen so that the valve will open with a pressure differential across the diaphragm in the range of 150-250 mm Hg. The different ranges of opening pressure differentials (i.e., “strengths”) of the valves (all having the same diameter) can be color-coded to more easily identify them. The thickness of membrane 47 can be the same, or different, than the thickness the sidewall 38 of tube 36.

In a preferred embodiment, diaphragm (32) is curved; having the liquid side (35) of the membrane convex, and the airside (39) of the membrane concave (e.g., FIG. 4H-J). Such design will facilitate the one-way airflow entry inward and prevent milk/liquid leakage outward. Alternatively, the diaphragm (32) can be substantially flat on both the liquid (35) and airside (39) (e.g., FIG. 4B). Alternatively, one side of diaphragm (32) can be substantially flat on the liquid side (35) and the airside (39) can be curved (FIG. 4E).

Diaphragm 32 can be positioned flush with the top end (41) of valve (30), as shown in FIGS. 4B, 4E, 4I. Alternatively, diaphragm (32) can be recessed inside of the tube, so that it does not protrude beyond the far end of the tube, as shown in FIG. 4H, 4J. Recessing the diaphragm can help protect its thin membrane during handling and cleaning.

As shown in FIGS. 4A-J, the tube's sidewall (38) comprises an circumferential retaining ring (33) designed to ensure a snug, leak-free fit when valve (30) is inserted into valve insert hole (21) from the outside of bottle (15). The use of retaining ring (33) allows valve (30) to “snap” into place when inserted, forming a leak-tight seal. The spacing between ring (33) and radial flange (37) depends on the thickness of the bottle's sidewall (e.g., 1-1.5 mm). The cross-sectional geometry of ring (33) can be, for example, semi-circular (see FIGS. 4A-H); or it can be triangular-shaped (43), with the triangle oriented to facilitate insertion, as shown in FIG. 4I.

In some embodiments, when valve 30 is inserted into valve insert hole 21, diaphragm 32 and retaining ring 33 reside interior to the sidewall of bottle/adaptor 15 and not solely within the confines of the bottle's/adaptor's sidewall 17. The phrase “interior to” is defined as the space between the central axis of bottle/adaptor 15 and the inner surface of sidewall 17.

In some embodiments, when valve 30 is inserted into valve insert hole 21, radial flange 37 resides completely outside of bottle's sidewall 17.

In the embodiment shown in FIG. 4J, sidewall 17 of bottle 15 can additionally comprise a cylinder 45 centered on valve insert hole 21 that protrudes/extends radially inwards towards the central axis of the bottle. Valve 30 is disposed inside of hole 21, with the valve being laterally supported by cylinder 45. The axial length of cylinder 45 can be slightly longer than the length of the valve itself; the same as the length of the valve; or it can be shorter than the length of the valve (as illustrated in FIG. 4J). The distance between ring (33) and flange (37) equals the length of the cylinder for easy ‘snapping’ into place to form a tight seal.

In one embodiment, the sidewall (38) of valve (30) can be tapered inwards (with its diameter narrower at the top end 41) to facilitate insertion (not illustrated).

The anti-vacuum valve (30) can be made of injection molded, solid color or transparent silicone that is free from Bisphenol-A, Phthalates, and Polyvinyl Chloride (PVC). A variety of colored silicones can be used. Alternatively, valve (30) can be made of any flexible, elastomeric material.

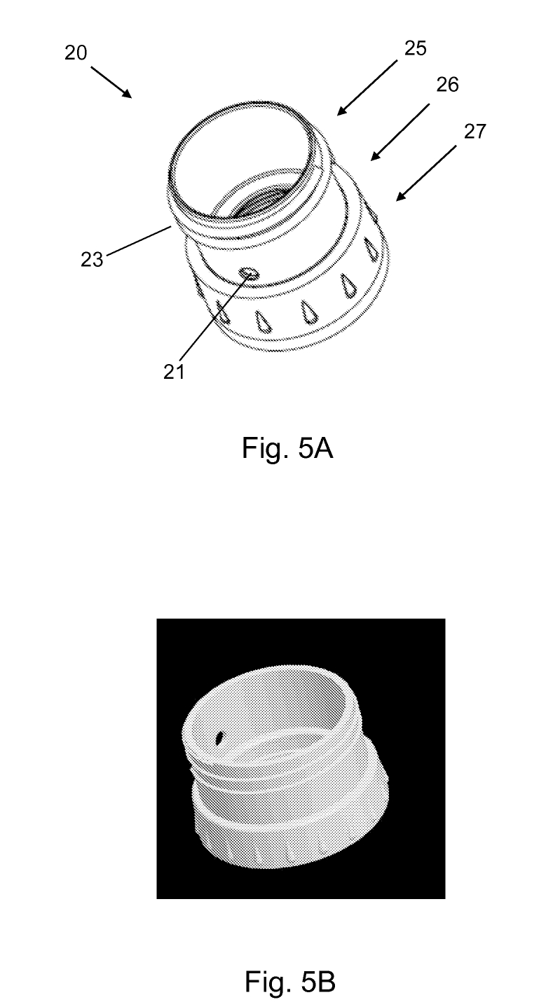

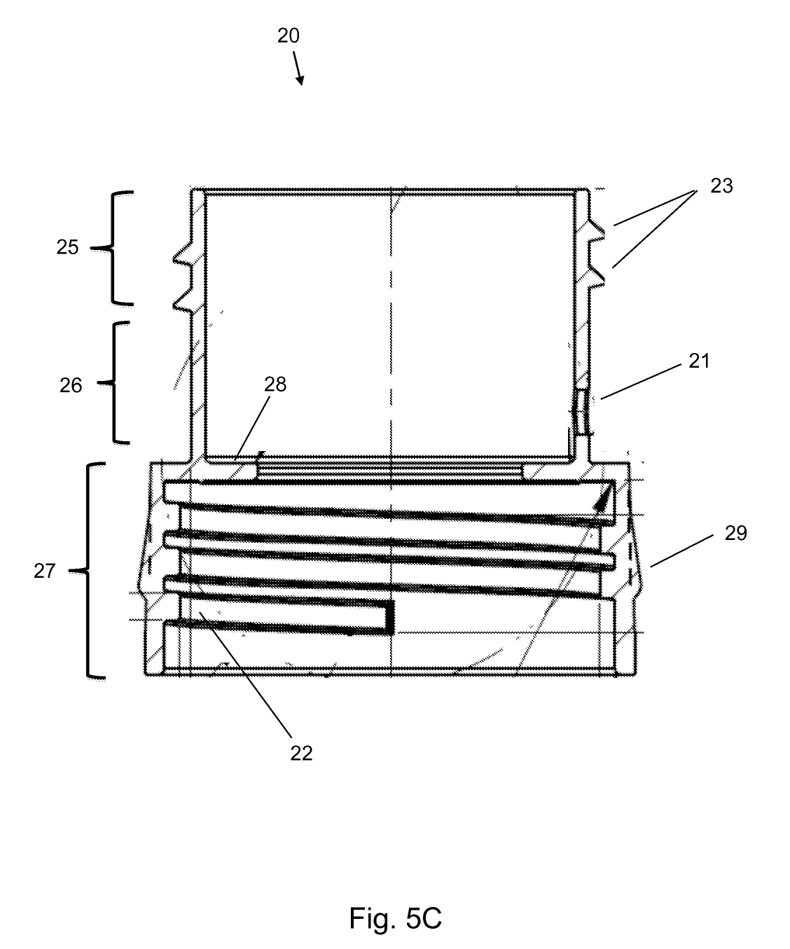

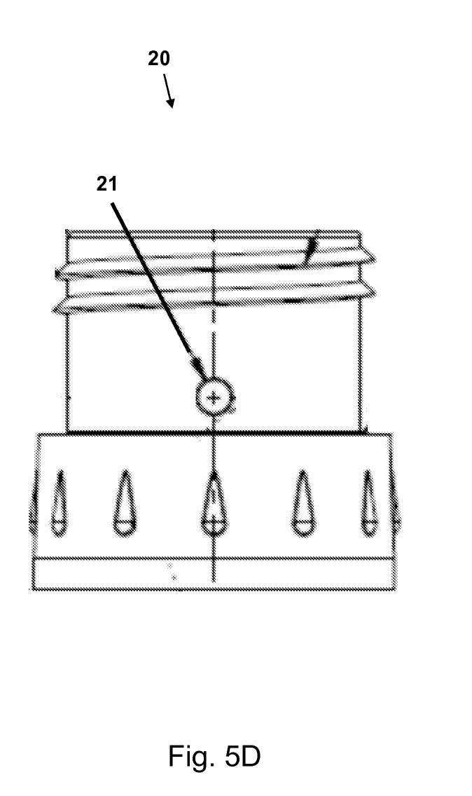

FIGS. 5A and 5B shows isometric and side views, respectively, of a first embodiment of an adaptor (20). Adaptor (20) comprises a hollow cylindrical body with three sections. The lower section (27) of the adaptor has internal threads (22) that can screw onto the bottle collar (14 of FIG. 3b). The middle section (26) has a valve insert hole (21) for holding an anti-vacuum, one-way valve (not shown). The upper section (25) of the adaptor has external threads (23) that can screw into a nipple crown (11 of FIG. 3b).

The diameter and height of the adaptor (20) can vary depending upon its use for standard or wide-base nipples. Adaptor (20) can additionally include an internal shoulder/ledge (28) that defines and limits the position of an O-ring seal (not shown). Shoulder (28) can include a circumferential, knife-edge protrusion for biting into an O-ring seal. The outside surface of the lower section (27) can comprise a plurality of knobs/protrusions (29), to aid in gripping the adaptor when being rotated. The adaptor (20) can be made of injection-molded, transparent or colored, Bisphenol-A free polypropylene.

The anti-vacuum valve 30 is not any part of the nipple 12. Also, the valve (30) is not located at the bottom end of the bottle/reservoir. Also, valve (30) is not located solely within the confines of the bottle's sidewall 17.

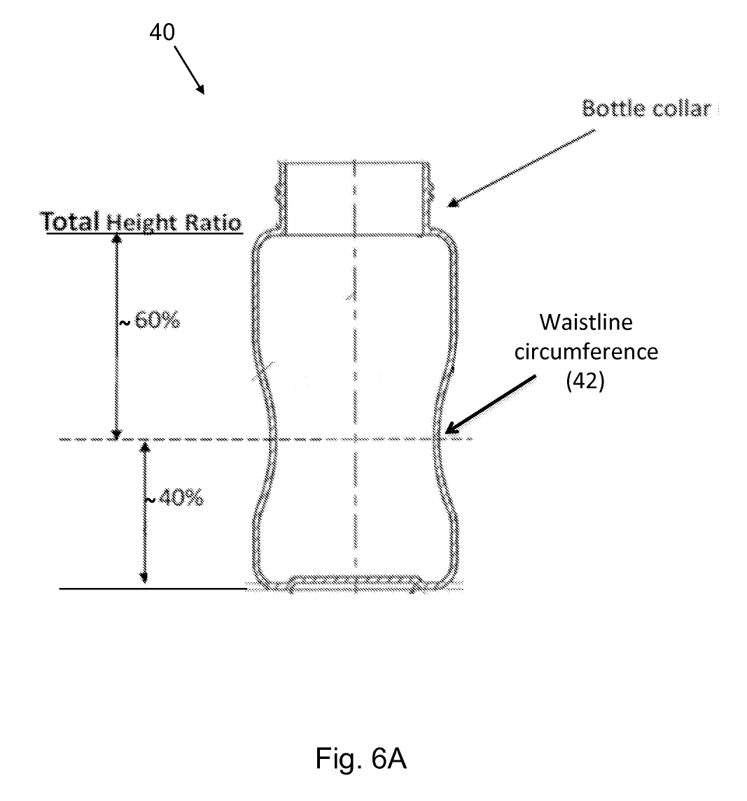

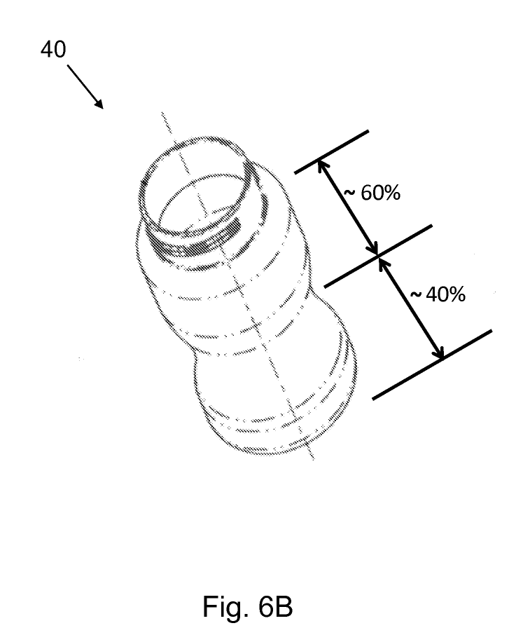

FIGS. 6A, 6B show an example of a wide-base ergonomic bottle (40), which can be produced at 180 ml or 240 ml (6 and 8 oz) sizes. An ergonomic design can help prevent repetitive hand and/or wrist strain injuries that may develop over time with frequent daily feedings. When a caregiver needs to hold a wide-base bottle weighing up to greater than 6 oz (when full) that is too wide to grasp firmly due to small hand size and at the same time needs to maintain a steady, continuously changing, inverted angle over prolonged feeding sessions, hand and wrist strain may develop. For this reason, the wide-base ergonomic bottle (40) can comprise a ‘waistline’ dividing the height of the bottle into two sections with an approximate 60:40 ratio of upper-to-lower heights. The ‘waistline’ circumference (42) can be approximately 7 to 7.5 in (18 to 20 cm). This allows the bottle to be held comfortably around the waist between the thumb and index finger leaving the upper part of the bottle (−60%) to be supported by the remaining three fingers spread in a fan-like manner with the little finger closest to the bottle collar (14) or nipple crown (11). A smooth, continued inversion of the bottle as milk empties is better controlled with the weight of milk distributed progressively between the three fingers spread in a fan-like manner, than solely using wrist rotations.

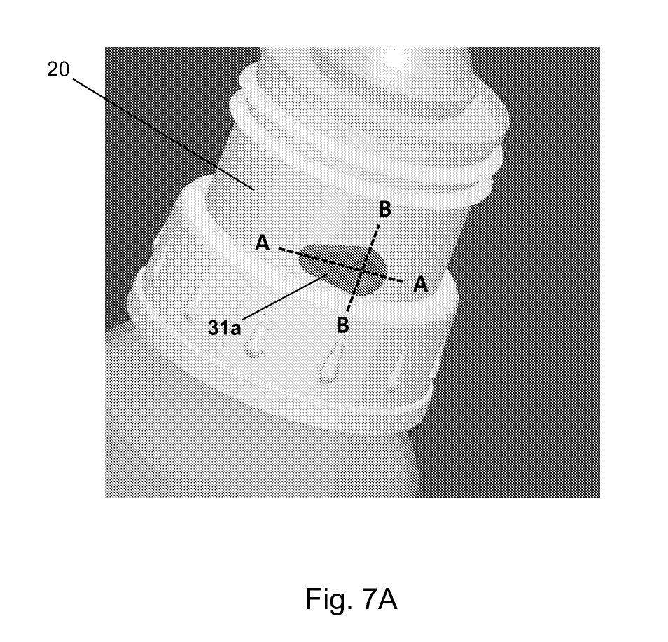

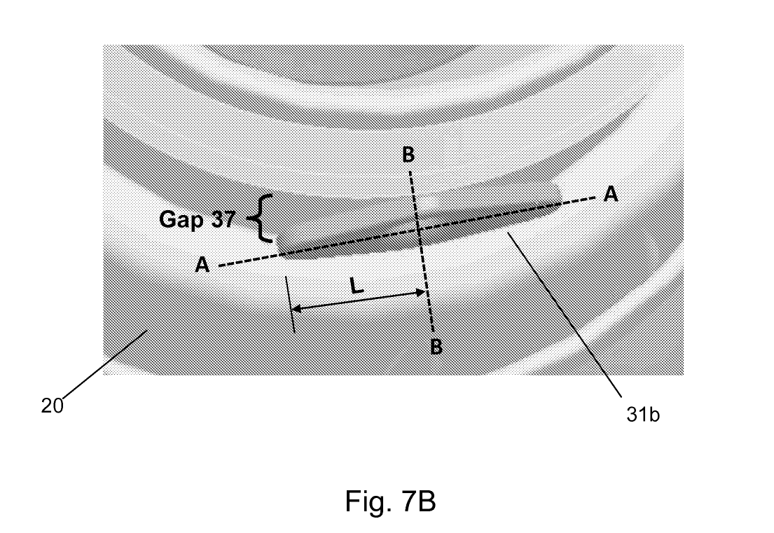

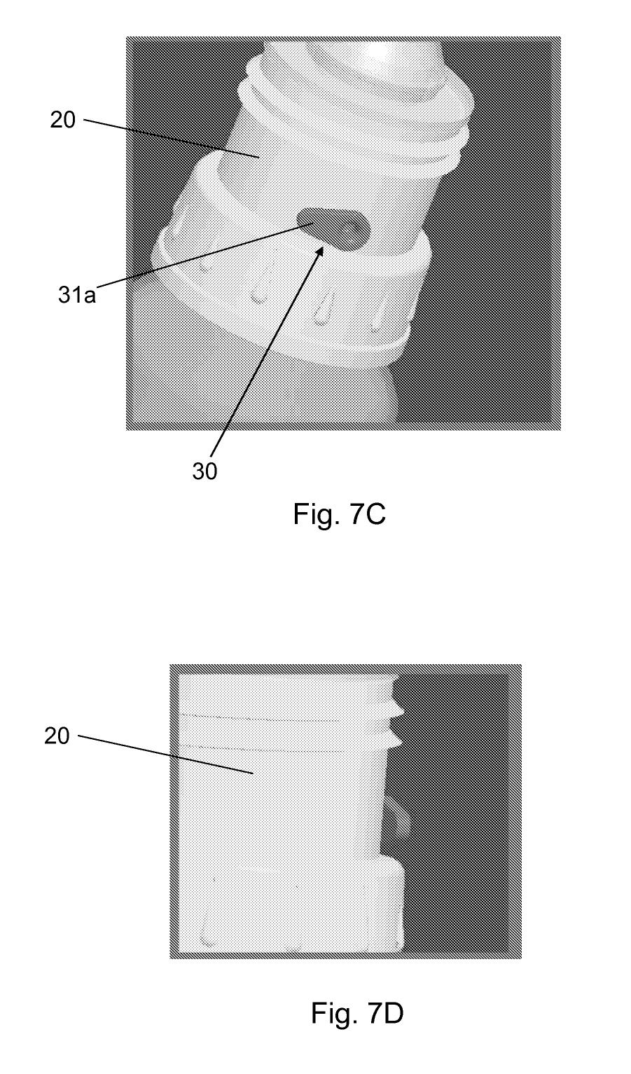

FIGS. 7A-D show a valve (30) inserted in an adaptor module (20). Valve (30), comprising one or more tabs (e.g., 31a, 31b), can be inserted into hole (21) in a variety of different orientations. Line “A-A” runs along the length of tab 31b, and line “B-B” is perpendicular to line “A-A”. In FIGS. 7A-D, valve (30) is oriented so that tab (31b) is aligned “sideways” (i.e., line “A-A” is perpendicular to the central axis of the bottle). An unexpected benefit of using the “sideways” orientation is shown in FIGS. 7B and 7D. Here, we can see that a gap (37) exists between the inner surface of tab (31b) and the outer surface of adaptor 20 (or bottle 15). The longer the length (L) of the tabs (e.g., 31a or 31b), the larger the size of gap (37) will be. Therefore, when valve (30) is oriented “sideways”, gap (37) opens up making it easier to grab the distal end of the tab (31a, 31b) with two fingers when inserting or removing the valve for cleaning or replacement.

FIG. 8A shows a schematic experimental test setup for the continuous measurement of internal vacuum build-up. As liquid is withdrawn from bottle, air enters through the anti-vacuum valve.

FIG. 8B shows a typical pressure trace versus time for a single suck.

FIG. 8C shows an example of an actual pressure trace using the test setup of FIG. 8A, with a valved bottle. The pressure trace shows re-equilibration of internal pressure to 1 atmosphere following each suck at amplitude of ˜2 mmHg. In this trace, the time (t₁) from start to end of suction equals 0.11 and 0.09 seconds for the 1^{st} and 2^{nd} sucks, respectively; and the time (t₂) from end of suction to the return to baseline pressure equals 0.3 and 0.2 seconds, respectively. The positive pressure seen just before each suck ensues from the stabilization of the nipple in the mouth prior to the generation of the suck.

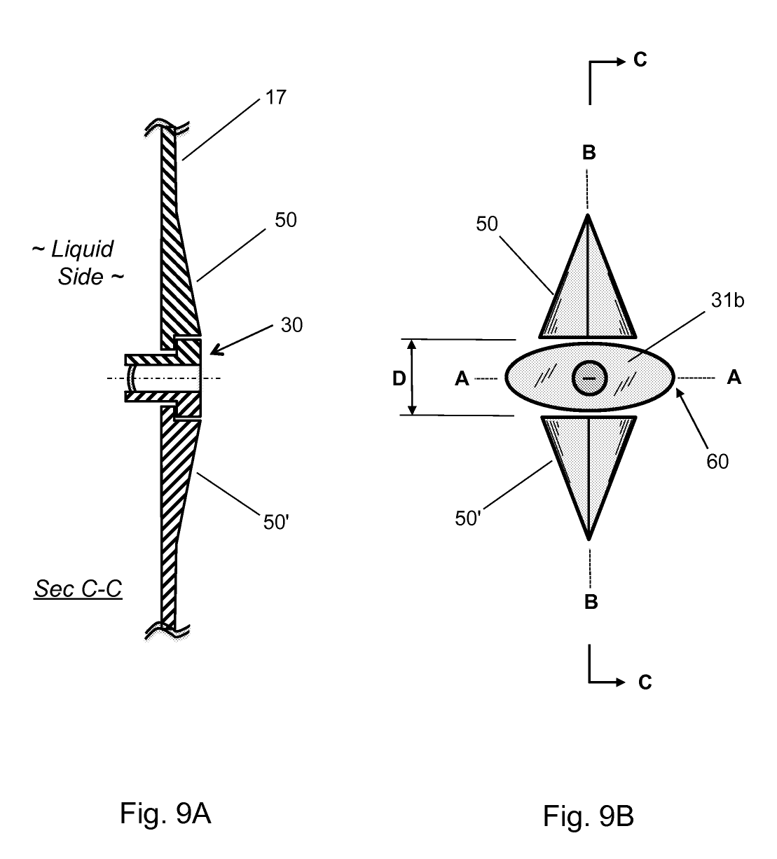

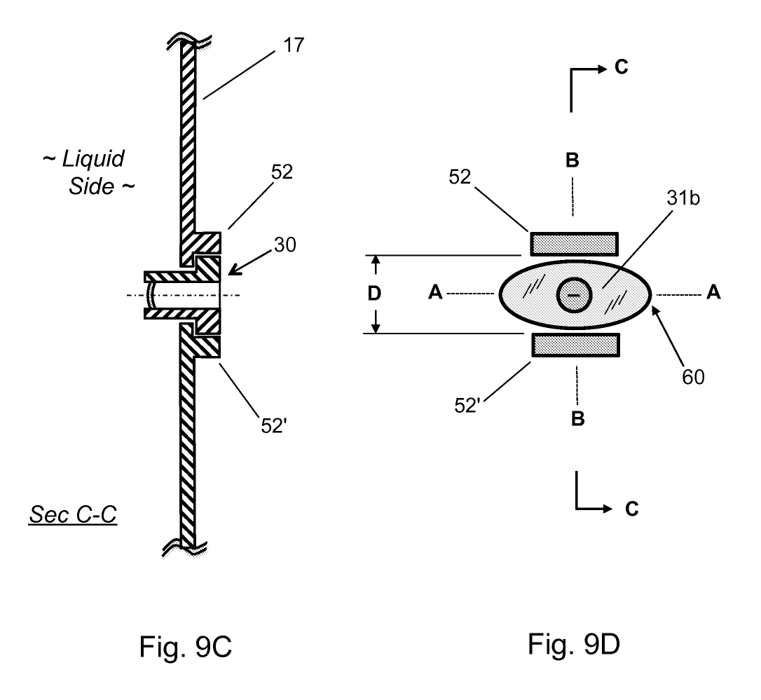

FIGS. 9A and 9B show cross-sectional and elevation views, respectively of a first example of a pair of valve guides 50, 50′, according to the present invention. The pair of guides 50, 50′ comprise raised bumps/pads that protrude radially outwards from the exterior surface of the bottle's (or adaptor's) sidewall 17, by a distance approximately equal to the thickness of radial flange 31 (e.g., symmetric tabs 31b). The pair of guides 50, 50′ are spaced apart by a distance, D, which is slightly larger than the width of radial flange 31b along the “B-B” line. The function of valve guides 50, 50′ is to constrain the orientation of valve 30 to be “sideways” (as previously defined in FIGS. 7A-D), which creates gap 37. In other words, the use of a pair of spaced-apart valve guides prevents the mis-installation of valve 30 in the vertical direction (which would have no gap 37). The shape of guides 50, 50′ can be roughly triangular (as in FIGS. 9A-B). Alternatively, the guides can be rectangular bars 52, 52′ (as shown in FIGS. 9C-D). The length of the guides can be approximately one-half of the length of the valve along line A-A, so that the tip 60 of tab 31b can be easily grasped.

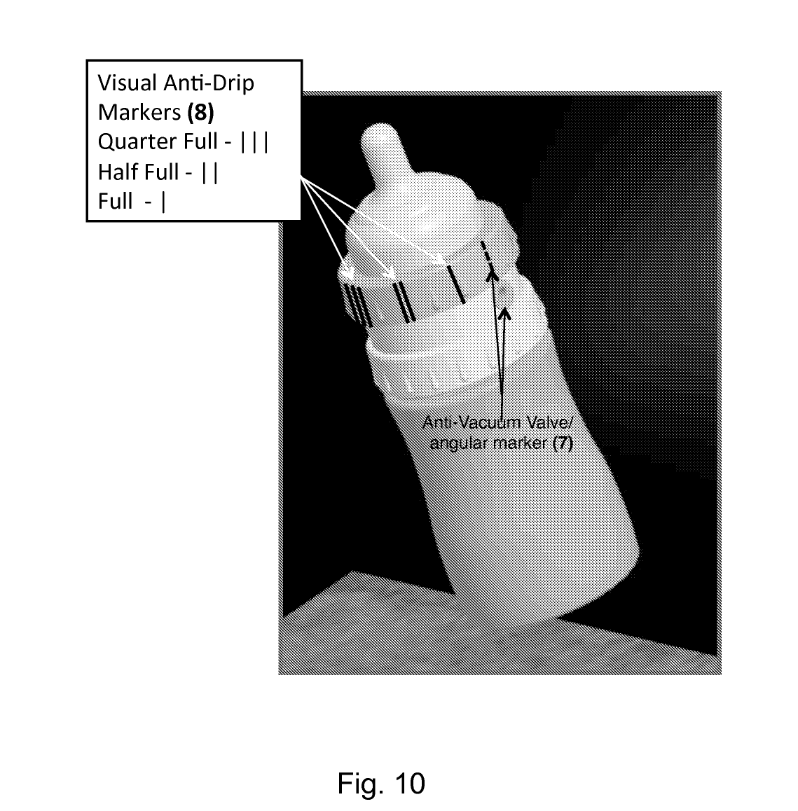

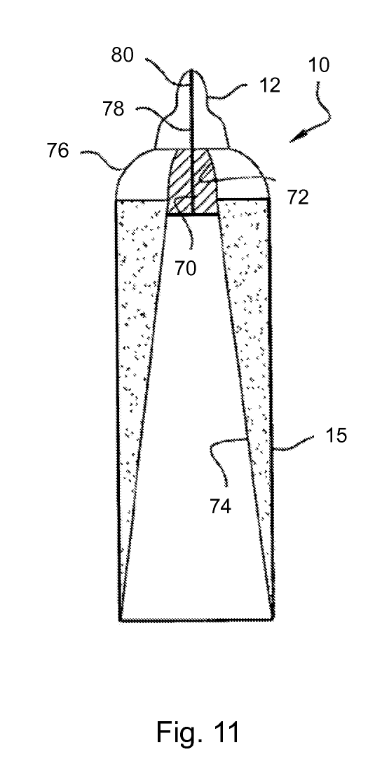

FIG. 10 shows an isometric view of an embodiment of an infant oral feeding system with multiple anti-drip marker lines, according to the present invention. This example uses 3 different marker lines (8), designated by a single line, a double line, or a triple line. The use of 3 sets of marker lines allows the caregiver to angle the bottle to the correct orientation that minimizes hydrostatic pressure, at three different volumes of fluid within the bottle. The single line is placed at approximately +/−45 degrees from the top marker (b), and corresponds to a bottle that is approximately full. The double line is placed at approximately +/−75 degrees from the top marker (7), and corresponds to a bottle that is approximately one-half full. Finally, the triple line is placed at approximately +/−90 degrees from the top marker (7), and corresponds to a bottle that is approximately one-quarter full.

In every embodiment where a threaded connection is shown, it is to be understood that other types of joining can be substituted for the threaded connection, which provide a functionally equivalent attachment or engagement. An example of an equivalent connection is a twist-lock connector. Others are well known in the art.

1. An oral feeding system, comprising a hollow cylinder; wherein the cylinder comprises: a sidewall, a central axis, an open top end, a valve insert hole disposed through the sidewall, and at least one anti-drip visual positioning marker means for eliminating hydrostatic pressure during feeding; wherein the valve insert hole is located near the open top end.

2. The feeding system of claim 1, further comprising a unidirectional, anti-vacuum valve inserted in the valve insert hole; wherein the valve comprises a monolithic body comprising:
a tube, having a sidewall and a central axis;
a near end, and an opposing far end;
a slit-type diaphragm that:
is located at, or near, the far end of the valve,
is continuous with the sidewall, and
comprises a membrane with a slit disposed through the membrane;
a radial flange that:
is located at the near end of the valve,
is continuous with the sidewall, and
extends radially outwards from the tube's sidewall in a direction perpendicular to the tube's central axis; and
a circumferential retaining ring that is continuous with the sidewall, and is disposed in-between the diaphragm and the radial flange; and
further wherein: a) the diaphragm resides interior to the cylinder's sidewall (and not solely within the confines of the cylinder's sidewall), b) the radial flange resides outside of the cylinder's sidewall, and c) the retaining ring resides interior to the cylinder's sidewall.

3. The feeding system of claim 2, wherein the hollow cylinder is a vented bottle comprising a closed bottom end, and a nipple held by a nipple crown that is attached to the open top end.

4. The feeding system of claim 3, wherein the bottle, nipple, and nipple crown are transparent.

5. The feeding system of claim 3, wherein the bottle is a wide-base ergonomic bottle with a waistline dividing a height of the bottle into two sections with an approximate 60:40 ratio of upper-to-lower heights.

6. The feeding system of claim 2, wherein the hollow cylinder is a vented adaptor comprising an open bottom end, an upper section comprising external threads, a middle section comprising the valve insert hole, and a lower section comprising internal threads.

7. The feeding system of claim 6, further comprising a nipple held by a nipple crown screwed onto the external threads; a standard feeding bottle with a threaded neck that is screwed into the adaptor's internal threads; and an O-ring fitted in-between the adaptor and the bottle; wherein the adaptor further comprises an internal shoulder that defines and limits the O-ring, and a circumferential knife-edge protrusion on the internal shoulder for biting into the O-ring.

8. The feeding system of claim 7, wherein the bottle, nipple, nipple crown, and adaptor are transparent.

9. The feeding system of claim 2, wherein the anti-vacuum valve comprises a slit-type diaphragm with a time constant of less than or equal to 0.2 or 0.4 seconds.

10. The feeding system of claim 2, wherein the anti-vacuum valve is easily removable from the valve insert hole.

11. The feeding system of claim 2, wherein the diaphragm of the valve is curved and has a convex side facing towards the central axis of the hollow cylinder, and an opposing concave side facing away from the central axis of the hollow cylinder.

12. The feeding system of claim 2, wherein the diaphragm of the valve has an opening pressure differential ranging from 1-10 mm Hg.

13. The feeding system of claim 2, wherein the radial flange comprises a single, non-circular, asymmetric tab extending radially outward from the valve's central axis to one side of the valve.

14. The feeding system of claim 2, wherein the radial flange comprises a symmetric pair of non-circular tabs extending radially outwards from the valve's central axis on opposite sides of the valve.

15. The feeding system of claim 2, wherein the diaphragm is recessed inside the tube, and does not protrude beyond the far end of the tube.

16. The feeding system of claim 2, wherein the radial flange comprises at least one tab with a tip extending radially outwards from the valve's central axis; and further wherein the valve is oriented with respect to the hollow cylinder's central axis in a direction such that a line drawn between the valve's central axis and the tip of the tab is oriented perpendicular to the cylinder's central axis, thereby forming a gap between the tip of the tab and the sidewall of the hollow cylinder.

17. An oral feeding system, comprising a vented bottle; wherein the bottle comprises: a sidewall, a central axis, a closed bottom, an open top with a threaded neck, a valve insert hole disposed through the sidewall, and at least one anti-drip visual positioning marker means for eliminating hydrostatic pressure during feeding; and further comprising an unidirectional, anti-vacuum valve inserted in the valve insert hole; wherein the valve comprises a monolithic body comprising:
a tube, having a sidewall and a central axis;
a near end, and an opposing far end;
a slit-type diaphragm that:
is located at, or near, the far end of the valve,
is continuous with the sidewall, and
comprises a membrane with a slit disposed through the membrane;
a radial flange that:
is located at the near end of the valve,
is continuous with the sidewall, and
extends radially outwards from the tube's sidewall in a direction perpendicular to the tube's central axis; and
a circumferential retaining ring that is continuous with the sidewall, and is disposed in-between the diaphragm and the radial flange; and
further wherein: a) the diaphragm resides interior to the bottle's sidewall (and not solely within the confines of the bottle's sidewall), b) the radial flange resides outside of the bottle's sidewall, and c) the retaining ring resides interior to the bottle's sidewall, when the valve is inserted in the valve insert hole;
the system further comprising a nipple held by a nipple crown that is screwed onto the threaded neck of the bottle; wherein the bottle, nipple, and nipple crown are transparent;
wherein the valve insert hole is located on the bottle's sidewall near the threaded neck of the bottle;
wherein the anti-vacuum valve comprises a slit-type diaphragm with a time constant of less than or equal to 0.2 seconds; the valve is easily removable from the valve insert hole; wherein the diaphragm of the valve is curved and has a convex side facing towards the central axis of the bottle, and an opposing concave side facing away from the central axis of the bottle; the diaphragm has an opening pressure differential ranging from 1-10 mm Hg; and the diaphragm is recessed inside the tube, and does not protrude beyond the far end of the tube;
wherein the bottle is a wide-base ergonomic bottle with a waistline dividing the height of the bottle into two sections with an approximate 60:40 ratio of upper-to-lower heights; and
wherein the radial flange comprises a single, non-circular, asymmetric tab extending radially outward to one side of the valve;
the radial flange comprises at least one tab with a tip extending radially outwards from the valve's central axis;
the valve is oriented with respect to the bottle's central axis in a direction such that a line drawn between the valve's central axis and a tip of the tab is oriented perpendicular to the bottle's central axis, thereby forming a gap between the tip of the tab and the sidewall of the bottle.

18. An oral feeding system, comprising a hollow cylinder; wherein the cylinder comprises: a sidewall, a central axis, an open top end, a valve insert hole disposed through the sidewall and located near the open top end, and a unidirectional, anti-vacuum valve inserted in the valve insert hole; wherein the valve comprises a monolithic body comprising:
a tube, having a sidewall and a central axis;
a near end, and an opposing far end;
a slit-type diaphragm that:
is located at, or near, the far end of the valve,
is continuous with the sidewall, and
comprises a membrane with a slit disposed through the membrane;
a radial flange that:
is located at the near end of the valve,
is continuous with the sidewall, and
extends radially outwards from the tube's sidewall in a direction perpendicular to the tube's central axis; and
a circumferential retaining ring that is continuous with the sidewall, and is disposed in-between the diaphragm and the radial flange; and
further wherein: a) the diaphragm resides interior to the cylinder's sidewall (and not solely within the confines of the cylinder's sidewall), b) the radial flange resides outside of the cylinder's sidewall, and c) the retaining ring resides interior to the cylinder's sidewall.

19. The feeding system of claim 18, wherein the hollow cylinder is a vented bottle comprising a closed bottom end, and a nipple held by a nipple crown that is attached to the open top end.

20. The feeding system of claim 18, wherein the hollow cylinder is a vented adaptor comprising an open bottom end, an upper section comprising external threads, a middle section comprising the valve insert hole, and a lower section comprising internal threads.

21. A unidirectional, anti-vacuum valve, comprising a monolithic body comprising:
a tube, having a sidewall and a central axis;
a near end, and an opposing far end;
a slit-type diaphragm that:
is located at, or near, the far end of the valve,
is continuous with the sidewall, and
comprises a membrane with a slit disposed through the membrane;
a radial flange that:
is located at the near end of the valve,
is continuous with the sidewall, and
extends radially outwards from the tube's sidewall in a direction perpendicular to the tube's central axis; and
a circumferential retaining ring that is continuous with the sidewall, and is disposed in-between the diaphragm and the radial flange.

22. The valve of claim 21, wherein the anti-vacuum valve comprises a slit-type diaphragm with a time constant of less than or equal to 0.2 seconds; the diaphragm of the valve has an opening pressure differential ranging from 1-10 mm Hg.

23. The valve of claim 21, wherein the radial flange comprises a single, non-circular, asymmetric tab extending radially outward from the valve's central axis to one side of the valve.

24. The valve of claim 21, wherein the radial flange comprises a symmetric pair of non-circular tabs extending radially outwards from the valve's central axis on opposite sides of the valve.

25. The valve of claim 21, wherein the diaphragm is recessed inside the tube, and does not protrude beyond the far end of the tube.

26. The valve of claim 25, wherein the diaphragm is curved, and has a convex side facing towards the far end of the valve, and an opposing concave side facing towards the near end of the valve.

27. The feeding system of claim 3, wherein the at least one anti-drip visual positioning marker means is disposed on a rotatably mounted crown.

28. The feeding system of claim 3, wherein the at least one anti-drip visual positioning marker means is disposed on an annular strip which is rotatably mounted on the nipple crown.

29. The feeding system of claim 3, wherein the at least one anti-drip visual positioning marker means is disposed on a covering crown rotatably mounted on a neck of the vented bottle.
